(19) United States
(12) Patent Application Publication
(10) Pub. No.: US 2024/0356939 A1
(43) Pub. Date: Oct. 24, 2024

(54) SECURITY ANALYSIS ASSISTANCE APPARATUS, SECURITY ANALYSIS ASSISTANCE METHOD, AND COMPUTER-READABLE RECORDING MEDIUM

(71) Applicant: NEC Corporation, Tokyo (JP)

(72) Inventor: Yusuke TAKAHASHI, Tokyo (JP)

(73) Assignee: NEC Corporation, Tokyo (JP)

(21) Appl. No.: 18/763,000

(22) Filed: Jul. 3, 2024

Related U.S. Application Data
(63) Continuation of application No. 17/285,957, filed on Apr. 16, 2021.

(51) Int. Cl. H04L 9/40; H04L 41/22; H04L 67/55

(52) U.S. Cl. CPC H04L 63/1416; H04L 41/22; H04L 63/1425; H04L 63/1466; H04L 63/20; H04L 67/55

(57) ABSTRACT

A security analysis assistance apparatus 10 is an apparatus for assisting security analysis in a network system of an organization. The security analysis assistance apparatus 10 includes: an analysis target obtaining unit 11 that obtains an alert generated in the network system; an information obtaining unit 12 that obtains organization address information specifying at least departments forming the organization and addresses used in the respective departments; an analysis unit 13 that compares the obtained alert with the organization address information, and analyzes the occurrence tendency of the alert for each department of the organization; and a visualization unit 14 that visualizes a result of the analysis performed by the analysis unit 13.

### CROSS REFERENCE TO RELATED APPLICATIONS

This application is a continuation of U.S. application Ser. No. 17/285,957 filed Apr. 16, 2021, which is a National Stage of International Application No. PCT/JP2018/039247 filed Dec. 22, 2018, the contents of all of which are incorporated herein by reference in their entirety.

### TECHNICAL FIELD

The invention relates to a security analysis assistance apparatus and a security analysis assistance method for assisting security analysis of a network system, and further relates to a computer-readable recording medium in which a program for realizing these is recorded.

### BACKGROUND ART

In recent years, network systems of organizations such as companies and government offices have become targets of cyber attacks for the purpose of data exploitation, destruction, and falsification. Accordingly, the administrator of the network system needs to analyze various alerts output from the network system, and respond to the cyber attacks.

Specifically, the administrator collects information related to cyber attacks distributed outside the organization, analyzes alerts output from the system, based on the collected information and internal-organization information such as correspondence between IP addresses and terminals, and determines the risk of the network system. The information inside the organization includes IP addresses and email addresses of terminals belonging to each department forming the organization. The reason why such internal-organization information is used is that, in a very large organization, the network system is also very large, and cyber attacks need to be dealt with for each department.

However, such analysis is performed manually, and the determination of a risk of the network system imposes a heavy burden on the administrator. Accordingly, Non-Patent Document 1 discloses a system for visualizing traffic in a network in real time. According to the system disclosed in Non-Patent Document 1, because the administrator can quickly grasp unauthorized traffic, it is considered that the burden on the administrator in determining the risk of the network system is reduced.

### LIST OF RELATED ART DOCUMENTS

### Non Patent Document

Non-Patent Document 1: Koei Suzuki, Masashi Eto, and Daisuke Inoue, “2-6 Development and Evaluation of NIRVANA: Real Network Traffic Visualization System”, National Institute of Information and Communications Technology, 2011, Review of the National Institute of Information and Communications Technology Vol. 57, Nos. 3/4 2011, p. 63-80

### SUMMARY OF INVENTION

### Problems to be Solved by the Invention

However, in the system disclosed in Non-Patent Document 1, traffic is visualized in units of IP addresses on a network topology, but is not visualized in units of departments of an organization. When a thin client service is introduced into a network system, it is difficult to specify a department by tracing the IP address of a terminal. Accordingly, when the administrator wants to determine the risk of the network system in units of departments of the organization, the system disclosed in Non-Patent Document 1 does not sufficiently reduce the burden in making the determination.

An example object of the invention is to provide a security analysis assistance apparatus, a security analysis assistance method, and a computer-readable recording medium capable of solving the above issues and assisting security analysis in units of departments in security analysis of a network system of an organization.

### Means for Solving the Problems

In order to achieve the example object described above, a security analysis assistance apparatus according to an example aspect of the invention is an apparatus for assisting security analysis in a network system of an organization, including:
an analysis target obtaining unit configured to obtain an alert generated in the network system;
an information obtaining unit configured to obtain organization address information specifying at least departments forming the organization and addresses used in the respective departments;
an analysis unit configured to compare the obtained alert with the organization address information, and analyze an occurrence tendency of the alert for each of the departments of the organization; and a visualization unit configured to visualize a result of analysis performed by the analysis unit.

In order to achieve the example object described above, a security analysis assistance method according to an example aspect of the invention is a method for assisting security analysis in a network system of an organization, including:
(a) a step of obtaining an alert generated in the network system;
(b) a step of obtaining organization address information specifying at least departments forming the organization and addresses used in the respective departments;
(c) a step of comparing the obtained alert with the organization address information, and analyzing an occurrence tendency of the alert for each of the departments of the organization; and
(d) a step of visualizing a result of the analysis performed in the (c) step.

Furthermore, in order to achieve the example object described above, a computer-readable recording medium according to an example aspect of the invention includes a program for assisting security analysis in a network system of an organization by a computer, the program being recorded on the computer-readable recording medium and including instructions that cause the computer to carry out:
(a) a step of obtaining an alert generated in the network system;
(b) a step of obtaining organization address information specifying at least departments forming the organization and addresses used in the respective departments;
(c) a step of comparing the obtained alert with the organization address information, and analyzing an occurrence tendency of the alert for each of the departments of the organization; and
(d) a step of visualizing a result of the analysis performed in the (c) step.

### Advantageous Effects of the Invention

As described above, according to the present invention, it is possible to assist security analysis in units of departments in security analysis of a network system of an organization.

### BRIEF DESCRIPTION OF THE DRAWINGS

FIG. 1 is a block diagram showing a schematic configuration of a security analysis assistance apparatus according to an example embodiment of the invention.

FIG. 2 is a block diagram showing the configuration of the security analysis assistance apparatus according to the example embodiment of the invention in more detail.

FIG. 3 is diagram showing an example of organization address information generated in the example embodiment of the invention.

FIG. 4 is diagram showing an example of visualization in the example embodiment of the invention.

FIG. 5 is flowchart showing operations performed by the security analysis assistance apparatus according to the example embodiment of the invention at the time of generating organization address information.

FIG. 6 is a flowchart showing the operation of the security analysis assistance apparatus according to the example embodiment of the invention during visualization processing.

FIG. 7 is a block diagram showing an example of a computer that realizes the security analysis assistance apparatus according to the example embodiment of the invention.

### EXAMPLE EMBODIMENT

### Example Embodiment

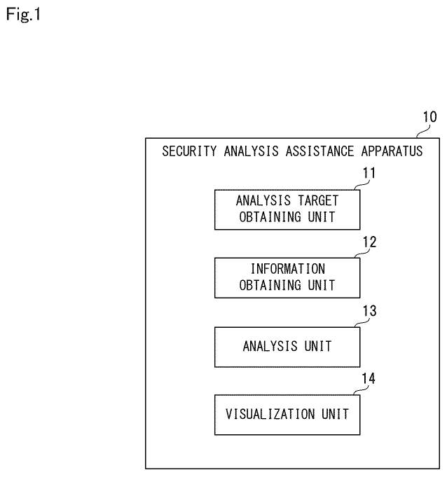

Hereinafter, a security analysis assistance apparatus, a security analysis assistance method, and a program according to an example embodiment of the invention will be described with reference to FIGS. 1 to 7.

### [Apparatus Configuration]

First, a schematic configuration of a security analysis assistance apparatus according to the example embodiment of the invention will be described with reference to FIG. 1. FIG. 1 is a block diagram showing a schematic configuration of the security analysis assistance apparatus according to the example embodiment of the invention.

A security analysis assistance apparatus 10 in the example embodiment shown in FIG. 1 is an apparatus for assisting security analysis in a network system of an organization. As shown in FIG. 1, the security analysis assistance apparatus 10 includes an analysis target obtaining unit 11, an information obtaining unit 12, an analysis unit 13, and a visualization unit 14.

The analysis target obtaining unit 11 obtains an alert generated in a network system. The information obtaining unit 12 obtains organization address information. The organization address information is information for specifying at least departments forming the organization and addresses used in the respective departments.

The analysis unit 13 compares the alert obtained by the information obtaining unit 12 with the organization address information. Then, the analysis unit 13 analyzes the occurrence tendency of the alert for each department of the specific organization, based on the result of the comparison. The visualization unit 14 visualizes the result of the analysis performed by the analysis unit 13.

As described above, in the security analysis assistance apparatus 10 according to the example embodiment, the occurrence tendency of the alert is analyzed for each the departments forming the organization, and the result is visualized. Accordingly, according to the security analysis assistance apparatus 10, it is possible to assist security analysis in units of departments in security analysis of a network system of an organization.

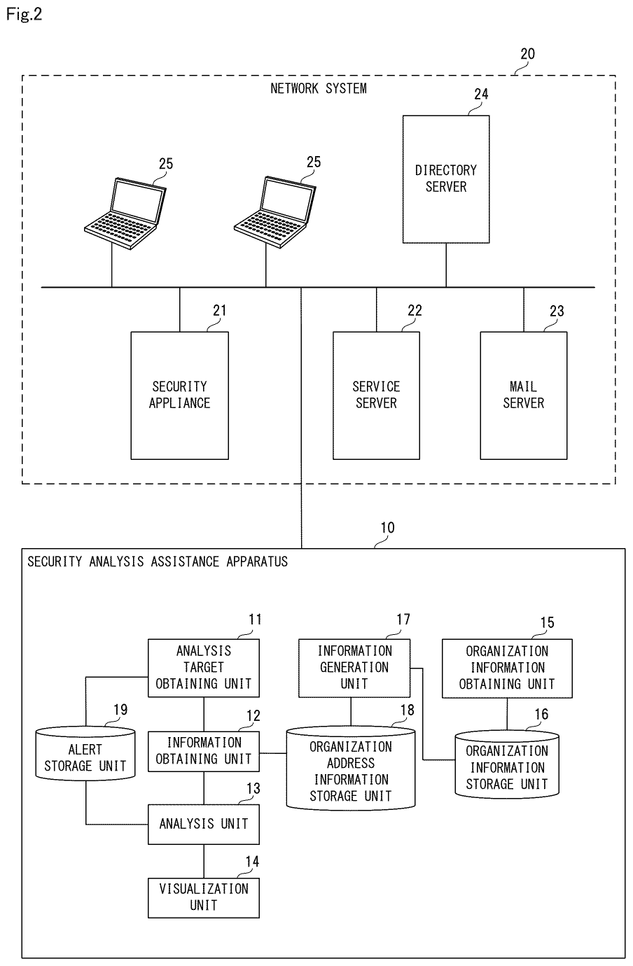

Next, with reference to FIGS. 2 to 4, the configuration and functions of the security analysis assistance apparatus 10 according to the example embodiment will be described in more detail. FIG. 2 is a block diagram showing the configuration of the security analysis assistance apparatus according to the example embodiment of the invention in more detail.

As shown in FIG. 2, the security analysis assistance apparatus 10 according to the example embodiment further includes an organization information obtaining unit 15, an organization information storage unit 16, an information generation unit 17, an organization address information storage unit 18, and an alert storage unit 19, in addition to the analysis target obtaining unit 11, the information obtaining unit 12, the analysis unit 13, and the visualization unit 14 described above.

As shown in FIG. 2, the security analysis assistance apparatus 10 is connected to a network system 20. The network system 20 includes network devices used in the organization, such as a terminal device, a server device, and a router. In the example of FIG. 2, a security appliance 21, a service server 22, a mail server 23, a directory server 24, and a terminal device 25 are illustrated.

The security appliance 21 is a server that manages the security of the system, and outputs an alert when, for example, a suspicious event, a malicious event, or the like occurs in the network system 20. In the example embodiment, the analysis target obtaining unit 11 obtains an alert from the security appliance 21. The analysis target obtaining unit 11 stores the obtained alert in the alert storage unit 19.

The service server 22 is a server that provides various services in the organization. In the example embodiment, the organization information obtaining unit 15 obtains, from the service server 22, organization information that specifies at least departments forming the organization, members of the departments, and email addresses of the members. Upon obtaining the organization information, the organization information obtaining unit 15 stores the obtained organization information in the organization information storage unit 16.

The information generation unit 17 specifies an email address of each member and an IP address corresponding to the email address (for example, an IP address of a terminal device that has transmitted and received emails), based on transmission processing and receiving processing of email used in the organization.

For example, it is assumed that a user name of an account authenticated by the mail server 23 is set as an email address. In this case, the information generation unit 17 specifies the email address (user name) and the IP address of the terminal device 25, when the terminal device 25 requests authentication from the mail server 23 and receives an email.

Specifically, the information generation unit 17 obtains a log of mail software used in the terminal device 25, data output by an agent program, and the like from a communication path between the terminal device 25 and the mail server 23, using DPI (Deep Packet Inspection), packet capture, or the like. Then, the information generation unit 17 obtains the email address (user name) and the IP address of the terminal device 25, based on the obtained data.

When the terminal device 25 transmits an email to the mail server 23, the information generation unit 17 can also specify an email address (user name) and the IP address of the terminal device 25. Specifically, in this case, the information generation unit 17 specifies an email address described by the MAIL command of the SMTP used when an email is transmitted and the IP address of the terminal device 25 of the transmission source from the communication path between the terminal device 25 and the mail server 23, using DPI, packet capture, or the like.

Furthermore, when the terminal device 25 requests the directory server 24 to perform authentication and the authentication is successful, the information generation unit 17 specifies the IP address of the terminal device 25 that requested the authentication and the information requested by the terminal device 25 from the directory server 24. The information generation unit 17 specifies the email address used in the terminal device 25 from the information requested by the terminal device 25.

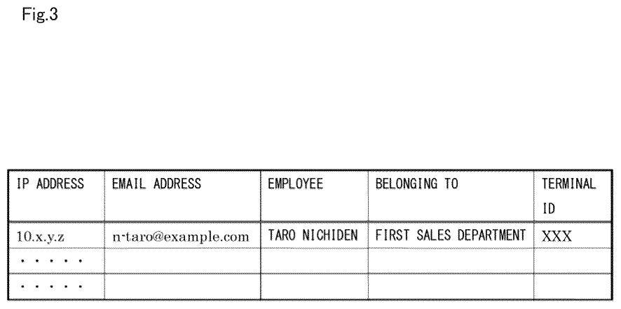

Thereafter, the information generation unit 17 compares the specification result with the organization information stored in the organization information storage unit 16, generates organization address information, and stores the generated organization address information in the organization address information storage unit 18. FIG. 3 is diagram showing an example of organization address information generated in the example embodiment of the invention. In the example of FIG. 3, the organization address information specifies IP addresses of terminal devices and email addresses, in addition to departments forming the organization, members of the departments, and identifiers (terminal IDs) of the terminal devices used by the members.

In the example embodiment, the information obtaining unit 12 obtains organization address information from the organization address information storage unit 18. The information obtaining unit 12 sends the obtained organization address information to the analysis unit 13.

In the example embodiment, for example, the analysis unit 13 calculates the number of occurrences of the alert for each department of the organization, thereby analyzing the occurrence tendency of the alert. In addition, when the organization has a hierarchical configuration, the analysis unit 13 analyzes the occurrence tendency of the alert for each department, from a higher-level department to a lower-level department.

In the example embodiment, for example, the visualization unit 14 visualizes the analysis result for each department, from a higher-level department to a lower-level department. Specifically, the visualization unit 14 creates image data for visualization and outputs the created image data to the terminal device of the administrator or a display device (not shown in FIG. 2). The visualization unit 14 can also switch the hierarchy of the department in which the analysis result is visualized. For example, the visualization unit 14 can switch from a state visualized for each higher-level department to a state visualized for each lower-level department.

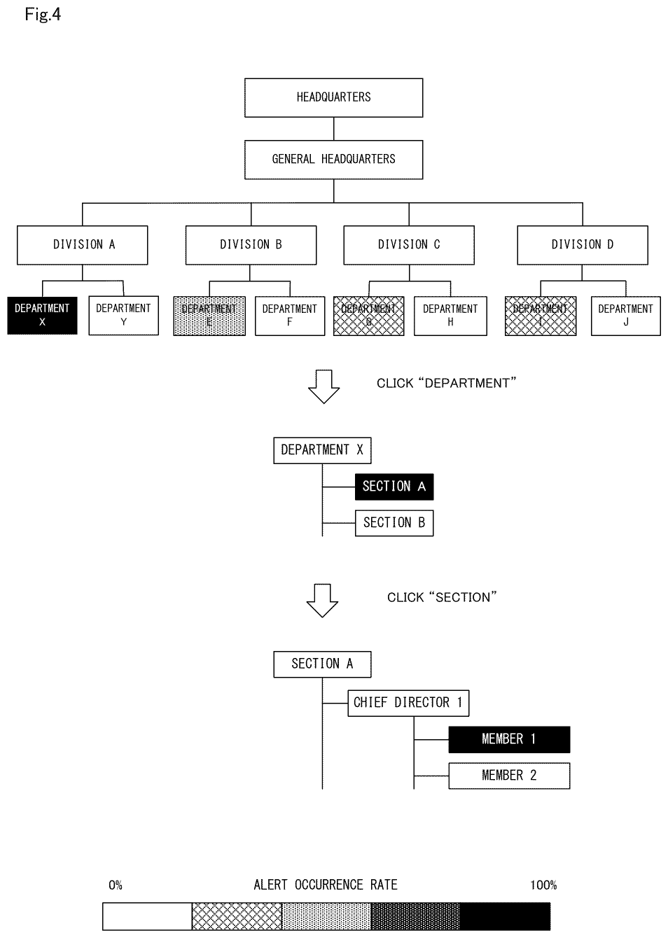

FIG. 4 is diagram showing an example of visualization in the example embodiment of the invention. In the example of FIG. 4, the screen is switched from the upper diagram to the middle diagram and to the lower diagram according to an operation made by the administrator of the security analysis assistance apparatus 10. In the upper diagram, an alert occurrence rate is shown for each higher-level department forming the organization. In the middle diagram, the alert occurrence rate is shown for each middle-level department (section) forming the higher-level department. In the lower diagram, the alert occurrence rate is shown for each group (member) forming the middle-level department.

### [Apparatus Operations]

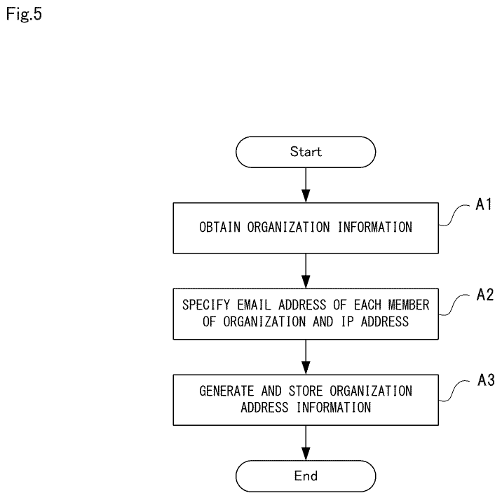

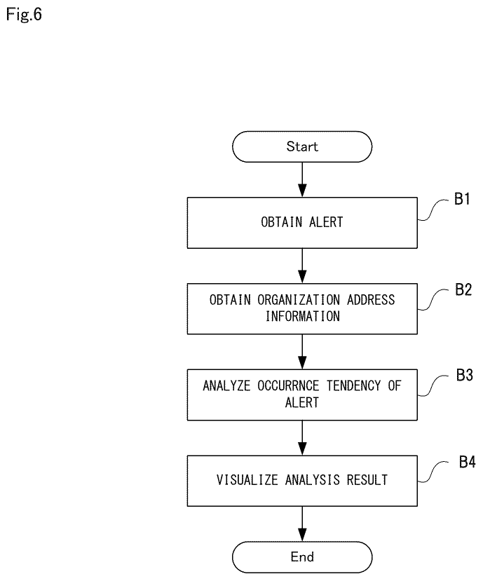

Next, the operations of the security analysis assistance apparatus 10 according to the example embodiment of the invention will be described with reference to FIGS. 5 and 6. In the following description, FIGS. 1 to 4 are referred to as appropriate. In the example embodiment, the security analysis assistance method is implemented by operating the security analysis assistance apparatus 10. Accordingly, the description of the security analysis assistance method in the example embodiment is replaced with the following description of the operations of the security analysis assistance apparatus 10.

First, the process for generating organization address information will be described with reference to FIG. 5. FIG. 5 is a flowchart showing the operations of the security analysis assistance apparatus according to the example embodiment of the invention at the time of processing for generating organization address information is performed.

As shown in FIG. 5, first, the organization information obtaining unit 15 obtains, from the service server 22, organization information that specifies at least departments forming the organization, members of the departments, and email addresses of the members (step A1). In step A1, once the organization information obtaining unit 15 obtains the organization information, the organization information obtaining unit 15 stores the obtained organization information in the organization information storage unit 16.

Next, the information generation unit 17 specifies the email address of each member and the IP address corresponding to the email address, based on the transmission processing and the receiving processing of the email used in the organization (step A2).

Next, the information generation unit 17 compares the specification result in step A1 with the organization information stored in the organization information storage unit 16 in step A1, generates organization address information, and stores the generated organization address information in the organization address information storage unit 18 (step A3).

Next, visualization processing will be described with reference to FIG. 6. FIG. 6 is a flowchart showing the operations of the security analysis assistance apparatus according to the example embodiment of the invention during visualization processing.

As shown in FIG. 6, the analysis target obtaining unit 11 obtains an alert from the security appliance 21, and stores the obtained alert in the alert storage unit 19 (step B1). Step B1 is performed, for example, for a predetermined period, and all alerts obtained during the period are stored in the alert storage unit 19.

Next, the information obtaining unit 12 obtains the organization address information from the organization address information storage unit 18, and sends the obtained organization address information to the analysis unit 13 (step B2).

Next, the analysis unit 13 extracts each alert stored in the alert storage unit 19, compares each extracted alert with the organization address information obtained in step B2, and analyzes the occurrence tendency of the alert for each department of the organization (step B3). Specifically, in step B3, the analysis unit 13 calculates the number of occurrences of the alert for each department of the organization, thereby analyzing the alert occurrence tendency.

Next, the visualization unit 14 visualizes the analysis result of the step B3 (step B41). As a result of executing step B4, the analysis result is visualized as shown in FIG. 4.

### Effects of Embodiment

As described above, in the example embodiment, the occurrence tendency of the alert is analyzed for the departments forming the organization, and the result is visualized. Further, in the example embodiment, the occurrence tendency of the alert is analyzed from the entire organization to the lower levels of the organization. As a result, according to the example embodiment, it is possible to assist security analysis in units of departments in security analysis of a network system of an organization.

In the example embodiment, the organization address information can be created in advance at a time different from the time when visualization processing is performed. Accordingly, it is possible to speed up the visualization processing, compared to a case where the visualization processing and the generation processing of the organization address information are simultaneously performed.

### [Program]

The program in the example embodiment may be a program that causes a computer to execute steps A1 to A3 shown in FIG. 5 and steps B1 to B3 shown in FIG. 6. The security analysis assistance apparatus and the security analysis assistance method according to the example embodiment can be realized by installing the program in a computer and executing the program. In this case, a processor of the computer functions as the analysis target obtaining unit 11, the information obtaining unit 12, the analysis unit 13, the visualization unit 14, the organization information obtaining unit 15, and the information generation unit 17, and performs processing.

In the example embodiment, the organization information storage unit 16, the organization address information storage unit 18, and the alert storage unit 19 can be realized by storing data files forming these units in a storage device such as a hard disk provided in a computer.

The program in the present embodiment may be executed by a computer system constructed by a plurality of computers. In this case, for example, each computer may function as any one of the analysis target obtaining unit 11, the information obtaining unit 12, the analysis unit 13, the visualization unit 14, the organization information obtaining unit 15, and the information generation unit 17. The organization information storage unit 16, the organization address information storage unit 18, and the alert storage unit 19 may also be constructed on a computer different from the computer that executes the program in the example embodiment.

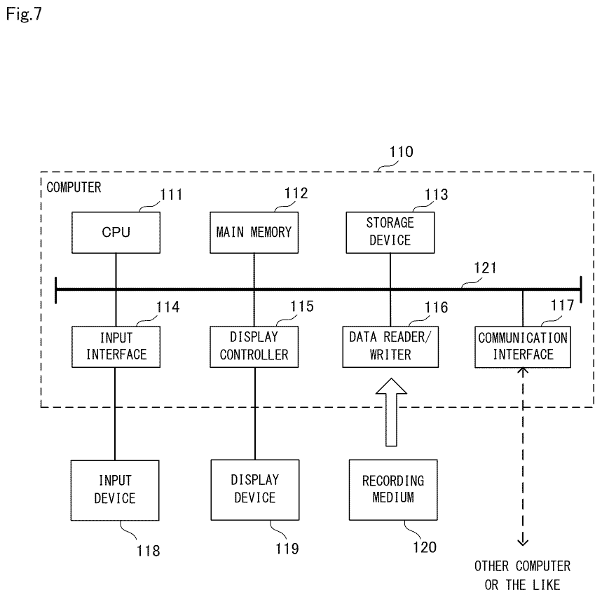

Here, a computer that realizes the security analysis assistance apparatus by executing the program according to the present embodiment will be described with reference to FIG. 7. FIG. 7 is a block diagram showing an example of a computer that realizes the security analysis assistance apparatus according to the example embodiment of the invention.

As shown in FIG. 7, a computer 110 includes a CPU (Central Processing Unit) 111, a main memory 112, a storage device 113, an input interface 114, a display controller 115, a data reader/writer 116, and a communication interface 117. These units are connected via a bus 121 so as to be capable of data communication between each other. The computer 110 may also include a GPU (Graphics Processing Unit) or an FPGA (Field-Programmable Gate Array) in addition to the CPU 111 or instead of the CPU 111.

The CPU 111 loads program (codes) according to the example embodiment, which are stored in the storage device 113, to the main memory 112, and executes the codes in a predetermined order, thereby performing various types of arithmetic operations. The main memory 112 is typically a volatile storage device such as a DRAM (Dynamic Random Access Memory). The program according to the example embodiment is provided in a state of being stored in a computer-readable recording medium 120. The program according to the example embodiment may also be distributed on the Internet connected via the communication interface 117.

Specific examples of the storage device 113 include a hard disk drive and a semiconductor storage device such as a flash memory. The input interface 114 mediates data transmission between the CPU 111 and input devices 118 such as a keyboard and a mouse. The display controller 115 is connected to a display device 119, and controls display on the display device 119.

The data reader/writer 116 mediates data transmission between the CPU 111 and the recording medium 120, and executes reading of a program from the recording medium 120 and writing of a processing result in the computer 110 to the recording medium 120. The communication interface 117 mediates data transmission between the CPU 111 and another computer.

Specific examples of the recording medium 120 include general-purpose semiconductor storage devices such as CF (Compact Flash (registered trademark)) and SD (Secure Digital), magnetic recording media such as a flexible disk, and optical recording media such as CD-ROM (Compact Disk Read Only Memory).

The security analysis assistance apparatus 10 according to the example embodiment can also be realized by using hardware corresponding to each unit, instead of a computer in which programs are installed. Furthermore, a portion of the security analysis assistance apparatus 10 may be realized by a program, and the remaining portion may be realized by hardware.

Some or all of the example embodiment described above can be expressed by (Supplementary Note 1) to (Supplementary Note 12) described below, but is not limited to the following description.

### Supplementary Note 1

A security analysis assistance apparatus that is an apparatus for assisting security analysis in a network system of an organization, including:
an analysis target obtaining unit configured to obtain an alert generated in the network system;
an information obtaining unit configured to obtain organization address information specifying at least departments forming the organization and addresses used in the respective departments;
an analysis unit configured to compare the obtained alert with the organization address information, and analyze an occurrence tendency of the alert for each of the departments of the organization; and
a visualization unit configured to visualize a result of the analysis performed by the analysis unit.

### Supplementary Note 2

The security analysis assistance apparatus according to Supplementary note 1, further including:
an organization information obtaining unit configured to obtain organization information specifying at least the departments forming the organization, members of each of the departments, and an email address of each of the members; and
an information generation unit configured to specify the email address of each of the members and an IP address corresponding to the email address based on transmission processing and receiving processing of email used in the organization, and further compare a specification result with the organization information and generate the organization address information.

### Supplementary Note 3

The security analysis assistance apparatus according to Supplementary note 1 or 2,
wherein the analysis unit analyzes, by calculating the number of occurrences of an alert for each of the departments of the organization, the occurrence tendency of the alert.

### Supplementary Note 4

The security analysis assistance apparatus according to any one of Supplementary notes 1 to 3,
wherein, when the organization has a hierarchical configuration,
the analysis unit analyzes the occurrence tendency of the alert for each of the departments, from a higher-level department to a lower-level department, and
the visualization unit visualizes the result of the analysis for each of the departments, from the higher-level department to the lower-level department.

### Supplementary Note 5

A security analysis assistance method that is a method for assisting security analysis in a network system of an organization, including:
(a) a step of obtaining an alert generated in the network system;
(b) a step of obtaining organization address information specifying at least departments forming the organization and addresses used in the respective departments;
(c) a step of comparing the obtained alert with the organization address information, and analyzing an occurrence tendency of the alert for each of the departments of the organization; and
(d) a step of visualizing a result of the analysis performed in the (c) step.

### Supplementary Note 6

The security analysis assistance method according to Supplementary note 5, further including:
(e) a step of obtaining organization information specifying at least the departments forming the organization, members of each of the departments, and an email address of each of the members; and
(f) a step of specifying the email address of each of the members and an IP address corresponding to the email address based on transmission processing and receiving processing of email used in the organization, and further comparing a specification result with the organization information and generating the organization address information.

### Supplementary Note 7

The security analysis assistance method according to Supplementary note 5 or 6,
wherein, in the (c) step, by calculating the number of occurrences of an alert for each of the departments of the organization, the occurrence tendency of the alert is analyzed.

### Supplementary Note 8

The security analysis assistance method according to any one of Supplementary notes 5 to 7,
wherein, when the organization has a hierarchical configuration, in the (c) step, the occurrence tendency of the alert is analyzed for each of the departments, from a higher-level department to a lower-level department, and
in the (d) step, the result of the analysis is visualized for each of the departments, from the higher-level department to the lower-level department.

### Supplementary Note 9

A computer-readable recording medium including a program for assisting security analysis in a network system of an organization by a computer, the program being recorded on the computer-readable recording medium and including instructions that cause the computer to carry out:
(a) a step of obtaining an alert generated in the network system;
(b) a step of obtaining organization address information specifying at least departments forming the organization and addresses used in the respective departments;
(c) a step of comparing the obtained alert with the organization address information, and analyzing an occurrence tendency of the alert for each of the departments of the organization; and
(d) a step of visualizing a result of the analysis performed in the (c) step.

### Supplementary Note 10

The computer-readable recording medium according to Supplementary Note 9, the program further including instructions that cause the computer to carry out:
(e) a step of obtaining organization information specifying at least the departments forming the organization, members of each of the departments, and an email address of each of the members; and
(f) a step of specifying the email address of each of the members and an IP address corresponding to the email address based on transmission processing and receiving processing of email used in the organization, and further comparing a specification result with the organization information and generating the organization address information.

### Supplementary Note 11

The computer-readable recording medium according to Supplementary note 9 or 10,
wherein, in the (c) step, by calculating the number of occurrences of an alert for each of the departments of the organization, the occurrence tendency of the alert is analyzed.

### Supplementary Note 12

The computer-readable recording medium according to any one of Supplementary notes 9 to 11,
wherein, when the organization has a hierarchical configuration, in the (c) step, the occurrence tendency of the alert is analyzed for each of the departments, from a higher-level department to a lower-level department, and
in the (d) step, the result of the analysis is visualized for each of the departments, from the higher-level department to the lower-level department.

Although the invention has been described with reference to the example embodiment, the invention is not limited to the above example embodiment. Various changes that can be understood by those skilled in the art can be made to the configuration and details of the invention within the scope of the invention.

As described above, according to the invention, it is possible to assist security analysis in units of departments in security analysis of a network system of an organization. The invention is useful for security analysis of a network system.

### REFERENCE SIGNS LIST

10 Security analysis assistance apparatus
11 Analysis target obtaining unit
12 Information obtaining unit
13 Analysis unit
14 Visualization unit
Organization information obtaining unit
16 Organization information storage unit
17 Information generation unit
18 Organization address information storage unit
19 Alert storage unit
Network system
21 Security appliance
22 Service server
23 Mail server
24 Directory server
Terminal device
110 Computer
111 CPU
112 Main memory
113 Storage device
114 Input interface
115 Display controller
116 Data reader/writer
117 Communication interface
118 Input device
119 Display device
120 Recording medium
121 Bus

1. A network system for improving computer security of an organization comprising;
a security analysis assistance apparatus;
a mail server;
terminal devices;
a communication network connecting the mail server, the terminal devices, and the security analysis assistance apparatus,
a security appliance configured to output security alerts of suspicious events occurred in the network system;
wherein
the security analysis assistance apparatus includes:
a memory configured to store instructions; and
a processor configured to execute the instructions to:
obtain the alerts from the security appliance, each of the security alerts identifying a network address of a device in the terminal devices, the device being a subject of each of the security alerts;
specify relation between a mail address used in each of the terminal devices and a network address of each of the terminal devices based on data of Deep Packet Inspection or packet capturing of a communication path between the mail server and the terminal devices or data obtained from a request of authentication from a terminal device in the terminal devices to the mail server;
obtain a mail address used in the device being a subject of each of the security alerts based on the specified relation;
obtain department information for identifying a department of the organization by specifying department information associated with the obtained mail address based on organization information, the department having the device, the organization information including department information and mail addresses used in the department;
analyze occurrence tendency of the security alerts for the department; and
visualize a result of the occurrence tendency.

2. The network system according to claim 1, wherein
the processor is configured to execute the instructions to
analyze the occurrence tendency of the security alerts for each department of each hierarchy in hierarchical configuration of the organization, and
visualize the occurrence tendency of the security alerts in aspect of the hierarchical configuration.

3. The network system according to claim 2, wherein
the processor is configured to execute the instructions to
visualize the occurrence tendency of the security alerts in aspect where occurrence rates of the security alerts are visualized.

4. The network system according to claim 3, wherein
the occurrence rates are categorized into a plurality of classes.

5. The network system according to claim 4, wherein
the processor is configured to execute the instructions to
visualize the occurrence tendency in aspect where a class of an upper department of a device with the highest class is the highest.

6. The network system according to claim 5, wherein
the processor is configured to execute the instructions to
visualize the occurrence tendency in aspect where occurrence tendency visualized for each higher-level department is switched to occurrence tendency visualized a lower-level department according to an operation.

7. A security device for improving computer security of an organization that has terminal devices connecting with a mail server and a security appliance which outputs security alerts of suspicious events occurred in the organization via a communication network, comprising;
a memory configured to store instructions; and
a processor configured to execute the instructions to:
obtain the alerts from the security appliance, each of the security alerts identifying a network address of a device in the terminal devices, the device being a subject of each of the security alerts;
specify relation between a mail address used in each of the terminal devices and a network address of each of the terminal devices based on data of Deep Packet Inspection or packet capturing of a communication path between the mail server and the terminal devices or data obtained from a request of authentication from a terminal device in the terminal devices to the mail server;
obtain a mail address used in the device being a subject of each of the security alerts based on the specified relation;
obtain department information for identifying a department of the organization by specifying department information associated with the obtained mail address based on organization information, the department having the device, the organization information including department information and mail addresses used in the department;
analyze occurrence tendency of the security alerts for the department; and
visualize a result of the occurrence tendency.

8. A method for improving computer security of an organization that has terminal devices connecting with a mail server and a security appliance which outputs security alerts of suspicious events occurred in the organization via a communication network, comprising;
obtaining the alerts from the security appliance, each of the security alerts identifying a network address of a device in the terminal devices, the device being a subject of each of the security alerts;
specifying relation between a mail address used in each of the terminal devices and a network address of each of the terminal devices based on data of Deep Packet Inspection or packet capturing of a communication path between the mail server and the terminal devices or data obtained from a request of authentication from a terminal device in the terminal devices to the mail server;
obtaining a mail address used in the device being a subject of each of the security alerts based on the specified relation;
obtaining department information for identifying a department of the organization by specifying department information associated with the obtained mail address based on organization information, the department having the device, the organization information including department information and mail addresses used in the department;
analyzing occurrence tendency of the security alerts for the department; and
visualizing a result of the occurrence tendency.
